(19) United States
(12) Patent Application Publication
(10) Pub. No.: US 2015/0015631 A1
(43) Pub. Date: Jan. 15, 2015

(54) ADAPTIVE CONTROL OF CONTINUOUS INKJET PARAMETERS

(71) Applicant: Dan C. Lyman, Cincinnati, OH (US)

(72) Inventor: Dan C. Lyman, Cincinnati, OH (US)

(21) Appl. No.: 13/939,220

(22) Filed: Jul. 11, 2013

(51) Int. Cl. B41J 2/045

(52) U.S. Cl. CPC B41J 2/04501
USPC 347/14

(57) ABSTRACT

A selected operating parameter of a device that operates in multiple operating states having differing natural response characteristics, at least one of which is variable over time, is controlled with a servo controller having control parameters which are responsive to the natural response characteristics. Sets of control parameters are provided to the servo controller corresponding to the operating states. One of the sets of control parameters corresponding to a given operating state is used by the servo controller to initiate control of the selected operating parameter in the given operating state. The response of the selected operating parameter in the given operating state is measured while the drive parameter is being controlled by the servo controller using the selected set of control parameters, and, if necessary, modified based on the response. The servo controller continues controlling the selected operating parameter using the modified set of control parameters.

### FIELD OF THE INVENTION

The present invention relates to the field of ink jet printing and, more particularly, to controlling operating parameters in a continuous ink jet printing system.

### BACKGROUND OF THE INVENTION

In continuous ink jet printing systems, it is necessary to control operating parameters, for example, vacuum and pressure levels, to specific target levels. These target levels change as the system is stepped through various operating states, for example, operating states associated with preparing the printhead for printing, shutting down the printhead, cleaning the printhead, or flushing the system. Accordingly, there is an ongoing need to improve control of the dynamic operating parameters included in the various operating states of ink jet printing systems.

### SUMMARY OF THE INVENTION

According to one aspect of the present invention, a method of controlling a selected operating parameter in a device that operates in multiple operating states which include differing natural response characteristics is provided. At least one of the natural response characteristics in at least one of the multiple operating states is variable over time. The selected operating parameter of the device is controlled by changes in a drive parameter of the device with a servo controller that includes control parameters which are responsive to at least one of the natural response characteristics. The method includes providing sets of control parameters to the servo controller with the sets corresponding to the multiple operating states of the device. One of the sets of control parameters corresponding to a given operating state of the device is selected to be used by the servo controller to initiate control of the selected operating parameter in the given operating state. A response of the selected operating parameter in the given operating state of the device is measured while the drive parameter of the device is being controlled by the servo controller using the selected set of control parameters. The selected set of control parameters used by the servo controller is modified based on the response. The selected operating parameter of the device in the given operating state continues to be controlled with the servo controller using the modified set of control parameters.

### BRIEF DESCRIPTION OF THE DRAWINGS

In the detailed description of the example embodiments of the invention presented below, reference is made to the accompanying drawings, in which:

FIG. 1 is a schematic block diagram of a printing system;

FIGS. 2A and 2B illustrate unacceptable system responses, for a system not incorporating the technique of the present invention;

FIGS. 3A and 3B illustrate acceptable system responses, for a system incorporating the technique of the present invention;

FIG. 4 shows a step in the drive parameter value, and the response of the controlled parameter to the step;

FIG. 5 shows a portion of a fluid system state table; and

FIG. 6 shows an example of a more complex drive parameter function for use in determining the control parameter values for a given fluid system state.

### DETAILED DESCRIPTION OF THE INVENTION

Throughout the specification and claims, the following terms take the meanings explicitly associated herein, unless the context clearly dictates otherwise. The meaning of “a,” “an,” and “the” includes plural reference, the meaning of “in” includes “in” and “on.”Additionally, directional terms such as “on”, “over”, “top”, “bottom”, “left”, “right” are used with reference to the orientation of the Figure(s) being described. Because components of embodiments of the present invention can be positioned in a number of different orientations, the directional terminology is used for purposes of illustration only and is in no way limiting.

The present description will be directed in particular to elements forming part of, or cooperating more directly with, an apparatus in accordance with the present invention. It is to be understood that elements not specifically shown, labeled, or described can take various forms well known to those skilled in the art. In the following description and drawings, identical reference numerals have been used, where possible, to designate identical elements. It is to be understood that elements and components can be referred to in singular or plural form, as appropriate, without limiting the scope of the invention.

The example embodiments of the present invention are illustrated schematically and not to scale for the sake of clarity. One of ordinary skill in the art will be able to readily determine the specific size and interconnections of the elements of the example embodiments of the present invention.

As described herein, the example embodiments of the present invention provide a printhead or printhead components typically used in inkjet printing systems. However, many other applications are emerging which use inkjet printheads to emit liquids (other than inks) that need to be finely metered and deposited with high spatial precision. Such liquids include inks, both water based and solvent based, that include one or more dyes or pigments. These liquids also include various substrate coatings and treatments, various medicinal materials, and functional materials useful for forming, for example, various circuitry components or structural components. As such, as described herein, the terms “liquid” and “ink” refer to any material that is ejected by the printhead or printhead components described below.

Inkjet printing is commonly used for printing on paper. However, there are numerous other materials in which inkjet is appropriate. For example, vinyl sheets, plastic sheets, textiles, paperboard, and corrugated cardboard can comprise the print media. Additionally, although the term inkjet is often used to describe the printing process, the term jetting is also appropriate wherever ink or other liquids is applied in a consistent, metered fashion, particularly if the desired result is a thin layer or coating.

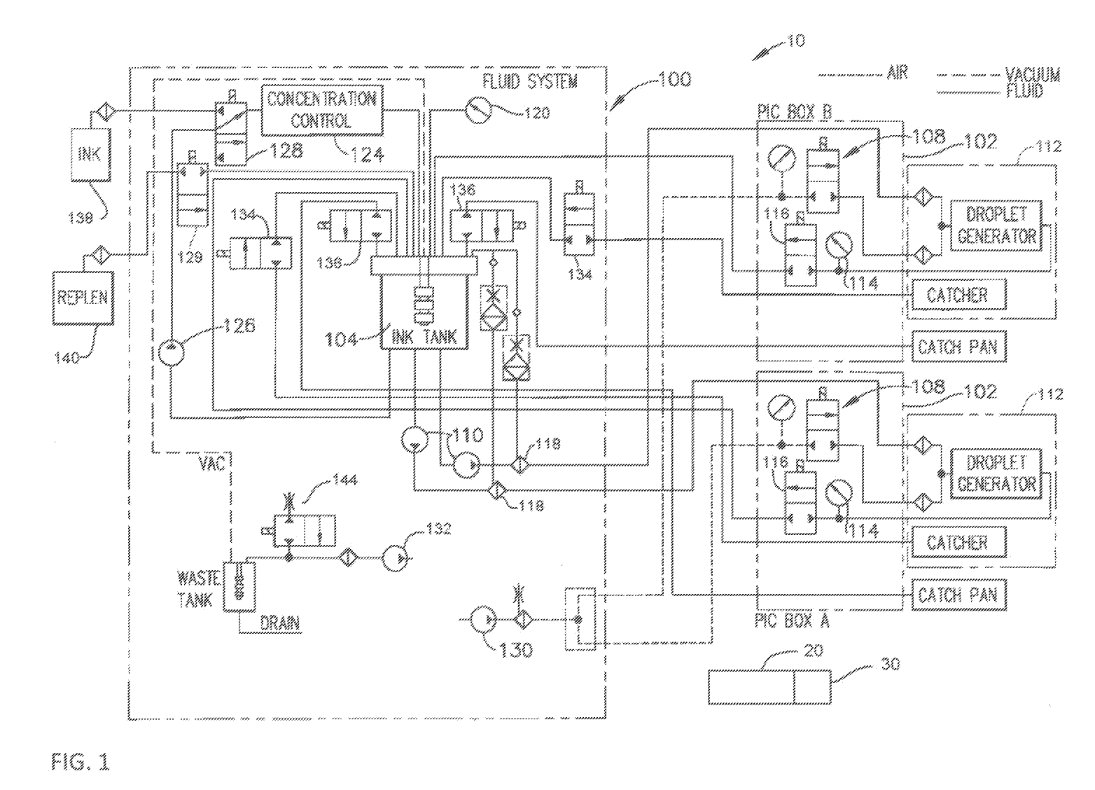

In continuous ink jet printing systems, ink is supplied under pressure by a fluid system 100 to the printhead 112, as shown in FIG. 1. Some of the ink drops formed by the printhead strike the paper to form the desired image. The remaining ink drops are made to strike the catcher. Vacuum in the ink reservoir 104 is used to return the ink from the catcher back to the ink reservoir, from which it can be reused. In normal operation, it is necessary to maintain vacuum to within about 0.5 in. Hg. of the target value, and pressure within about 0.2 psi of the target in order for the system to function properly.

If vacuum is too high, uncharged drops, which should end up being printed, are instead sucked into the catcher. Large amounts of foam can also be generated in the ink reservoir. If vacuum is too low, the system cannot remove ink quickly enough from the catcher face, and ink drips down onto the print media, degrading the quality of the printed product. Similarly, if the ink pressure is too high or too low, drop formation and drop deflection can be seriously affected, again resulting in degradation of the final product.

To maintain the proper vacuum and ink pressure levels, ink jet printers typically incorporate a controller system. The controller system includes sensors to determine the values of the parameters to be controlled, for example, pressure and vacuum; a controller including control electronics, and the ability to adjust a drive parameter(s), for example, the voltage supplied to a pump. The parameter to be controlled to a target value by the control system by adjusting a drive parameter is called a controlled parameter. One common form of control electronics includes a Proportional-Integrate-Differentiate (PID) control system. PID controllers are used as they can provide reduced fluctuation of the control parameters, fast settling times, and lack of oscillation.

When such PID controllers are used, the stability of the controller, the response rate, and the amount of overshoot depend on the control parameters such as multiplier values, used for each stage of the controller. Note as used herein, control parameters are distinct from the controlled parameter and the target value of the controlled parameter. The control parameters serve to tune the control system to account for natural system response of the controlled parameter to changes in the drive parameter, which is also called a driven parameter. The control parameters used in the PID controller are ideally selected based on the natural response rates of the system to be controlled. Using control parameter values that are sufficiently to one side of the ideal values can produce instability, that is, the value of the controlled parameter can go into oscillation. Control parameters values that are sufficiently to the other side of the ideal values can result in slow settling times and larger than ideal fluctuations of the controlled parameter. If the system gain and response rates change for different conditions, the control parameters used by the PID controller may no longer be optimal. If the changes are small, there may be a minor effect on the controller settling rate or overshoot. If the values change more significantly, the controller may become unstable, and could oscillate, or the settling rates or overshoot may become unacceptable.

Other control systems such as deadbeat control systems also have set of control parameters, whose values affect the stability of the controlled parameter as well as the rate at which the controlled parameter approaches or settles at a target value. The invention is appropriate for use with any such control systems that have sets of one or more control parameters that govern the response characteristic of the control system.

Referring back to FIG. 1, a schematic of a printing system 10 is shown. The printing system includes a fluid system 100, which is capable of independently and simultaneously controlling the integration of multiple print heads 112. The operation of the fluid system 100 and of the printheads 112 is controlled by a system controller 20. The printheads 112 each interface with the fluid system and the system controller by means of a separate print head interface controller (PIC) box 102. The system controller can control the operation of the various valves and pumps of the system to control the operation of the printing system while it is printing. The system controller can also set the printing system through various sequences of operating states (each state having defined open/closed conditions for each of the valves and drive conditions for each of the fluid system pumps) to facilitate reliable startups and shutdowns of the printheads.

Under the control of the system controller, individual ink pumps 110 withdraw ink from the ink tank 104 and supply the ink to the individual print heads 112. Each pump 110 is typically driven by a variable speed brushless VDC motor which allows the pressure or flow rate of liquid supplied to each print head by varying the voltage applied to the pump. The pressure of the liquid supplied to the printhead 112 is measured by pressure sensor 114. While in print mode, the outlet valve 116 is closed enabling the liquid pressure in the droplet generator to rise to a level sufficient for liquid to continuously jet from the nozzles of the droplet generator. During startup and shutdown sequences of the printhead, it is desirable to flush fluid through the droplet generator of the printhead 112 to flush debris from the droplet generator. This crossflush function is enabled by opening the outlet valve 116 while liquid is pumped to the printhead and vacuum is maintained on the ink tank facilitate the return of the liquid from the printhead to the ink tank 104.

In a typical ink jet printer, the vacuum level provided by the vacuum pump 132 is controlled by adjusting the pump speed or, for control purposes, pump voltage. Alternatively, the vacuum level can be controlled by adjusting one or more air bleeds 144 through which air is bred into the vacuum system, as is described in U.S. Pat. No. 5,394,177. As the controller steps through the various sequences of operating states, the servo controller 30 portion of the system controller 20 measures the vacuum level by means of vacuum sensor 120 and adjusts the vacuum level to bring it to the target level associated with each operating state.

A concentration control sensor 124 monitors the ink concentration. Ink is circulated through the concentration sensor from the ink tank by a small separate fluid pump 126. In this way, the flow through the sensor is independent of the flow to either of the print heads. The concentration control system is configured such that when the fluid system 100 fills with fresh ink, ink passes through a valve 128 at the inlet of the concentration sensor and passes through the sensor. In this way, the sensor can be calibrated against fresh ink. The fluid system control electronics monitors the output of this sensor and the output of the ink tank level sensors as it controls the addition of ink to the ink tank from the ink supply 138 via ink refill valve 128 or of replenishment fluid to the ink tank 104 from replenishment supply 20 via replenishment valve 129.

Checking the concentration of makeup ink with the concentration sensor as the ink is added to the fluid system can also provide a failsafe test to prevent the wrong type or color of ink from being added to the fluid system.

A positive air pump 130 supplies clean air into the fluid lines. The positive air pump in fluid system 100 provides clean air through air valves 108 to each droplet generator during shutdown to help remove ink from the print heads of both print heads. The function of this air pump is described in more detail in U.S. Pat. No. 6,273,013.

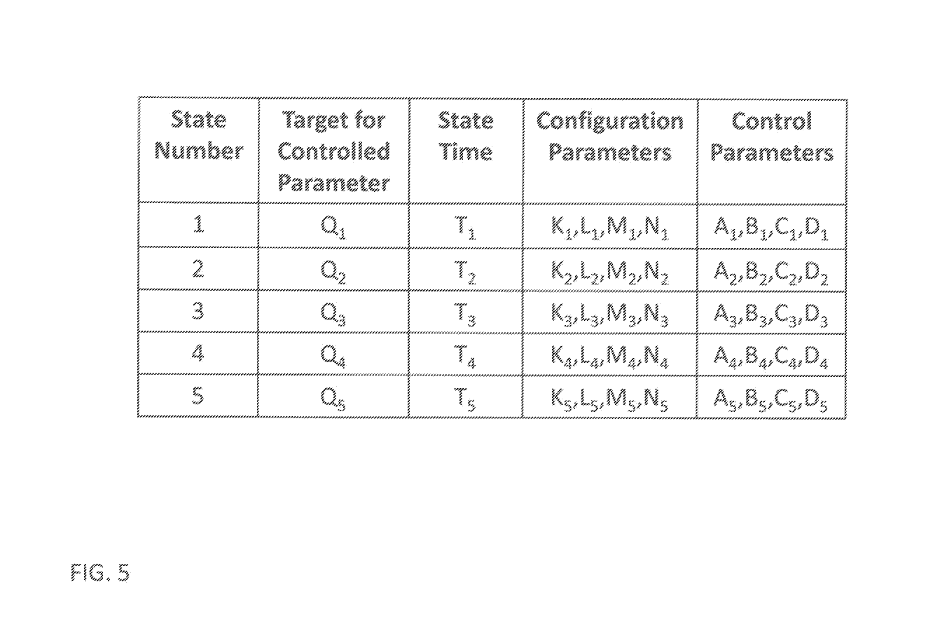

As mentioned, the printing system has various operation sequences made up of a series or sequence of operating states. These sequences facilitate the startup, shutdown and cleaning of the printhead and fluid system and potentially over functions. Each of the operating states has associated with them the open/closed configuration for each of the valves as well as target values for the controlled parameters such as supplied liquid flow and system vacuum, and also the duration of the operating state. FIG. 5 shows a table illustrating a five-step portion of a sequence of fluid system states. The state number is in the first column from the left. The second column illustrates that each of the fluid system states can have different target values Qᵢ for the controlled parameter, for example for the supplied ink pressure. The third column illustrates that each state can have a different duration or state time Tᵢ. The fourth column illustrates the configuration parameters K₁, L₁, M₁, and N1 for the fluid system state, such as the open/closed configuration of different valves in the fluid system. Although four configuration parameters are shown for illustration in FIG. 5, the number of configuration parameters can vary. Furthermore, the configuration parameters are not limited to the open or closed status of the valves. The configuration parameters can also include whether various functions are enabled or deactivated such as whether an air pump is turned on or off, or whether the concentration control system is enabled to actively control the ink level and concentration in the reservoir or that function is disabled. The right-most column is discussed below.

The natural response of the controlled parameters to changes in a drive parameter in such a fluid system depends on the fluid system configuration as defined by the configuration parameters. To understand this, the natural response of the vacuum level in the reservoir to changes in the vacuum pump drive level is considered. The vacuum in the reservoir depends not only on the voltage applied to the vacuum pump, but also the amount of air allowed to enter the vacuum system through various routes, such as the catcher and catch pan lines via catcher valve 134 and catch pan valve 136, respectively, and other possible air bleeds 144. As more air bleed routes are closed through the closing of the appropriate valve, a small change in vacuum pump voltage will make a bigger change in the vacuum level. That is, the gain of the vacuum system response increases as air bleed valves are closed. As the amount of damping of the vacuum response is affected by the flexibility of the various fluid lines, opening or closing the various air bleed valves, which effectively can alter the amount of fluid lines present that can affect damping. In a similar manner, the natural response of the ink pressure depends on whether the outlet valve 116 from the printhead is open or closed.

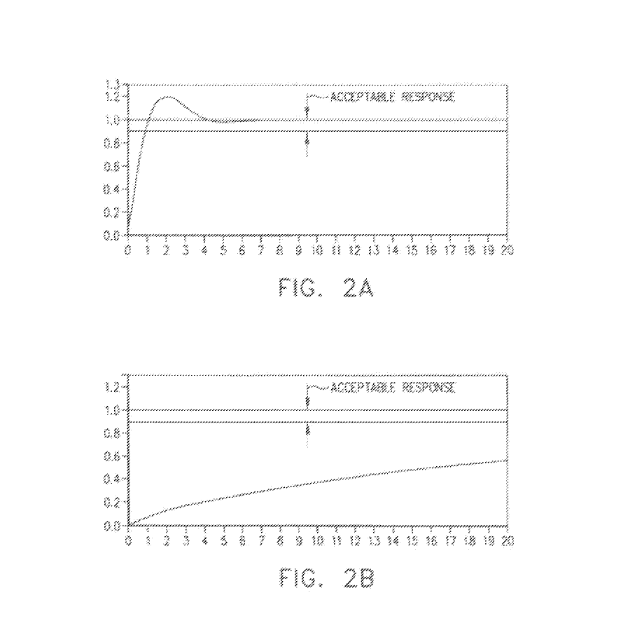

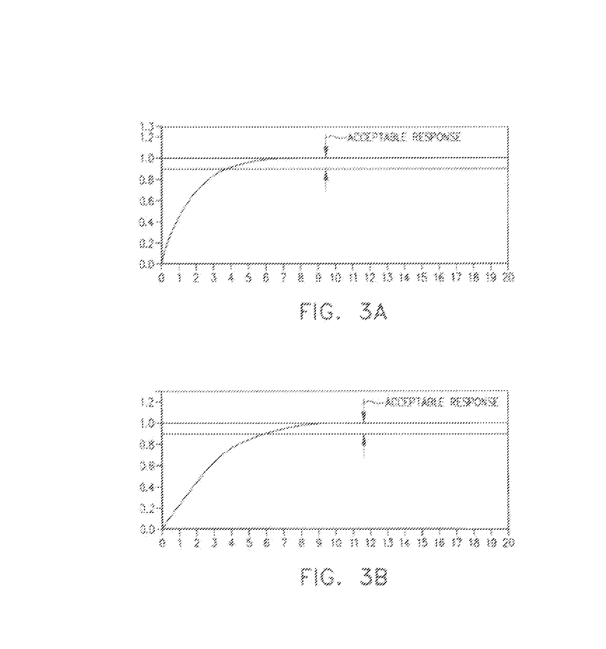

The effect of these changes in the natural system response produced by the different valve or bleed conditions is illustrated in FIGS. 2A, 2B, 3A, and 3B. In the graph of FIG. 3A, the response of the system is illustrated when the catcher valve 134 and the catcher pan valve 136 are closed and the vacuum controller control parameters are near the optimum values for natural system response. In about 8 time units, the value of the controlled parameter has settled to the desired value. When the catcher valve 134 and the catcher pan valve 136 are opened, the natural system response changes. Attempting to control the vacuum level with these valves open while using the control parameters that were optimal with valves closed can lead to unacceptable overshoot as shown in FIG. 2A. Adjusting the control parameters of the vacuum control system to account for the natural system response of the system with the catcher valve 134 and the catcher pan valve 136 open again leads to the level of the controlled parameter (vacuum) quickly settling in at the desired value, as shown in FIG. 3B. Using these same control parameters, which are optimal for the fluid system state having the catcher valve 134 and the catcher pan valve 136 open, yields an unacceptably slow response, as shown in FIG. 2B in fluid system states having the catcher valve 134 and the catcher pan valve 136 closed. To enable the servo control to control the controlled parameter with the desired response rate, the servo control can use different control parameters for each of the fluid system states. The right-most column in the table of FIG. 5 illustrates the control parameter values for each state.

In addition to being sensitive to the status of various valves which differ from one fluid system state to another, the natural system response can also be sensitive to the component makeup of the fluid system. For example, different fluid pumps 110 may have different drive voltage to output flow characteristics, which can affect the natural system response. Similarly, the flow impedance of the ink filters 118 can also affect the natural system response. The flow impedance of the ink filters 118 can vary with the particle loading of the filter; as more and more particles are captured by the filter the flow impedance increases. The flow impedance of the filters and other components also depends on the viscosity of the ink. As a result of such component related differences, the natural system response can vary from printing system to printing system, and also over time for a given printing system.

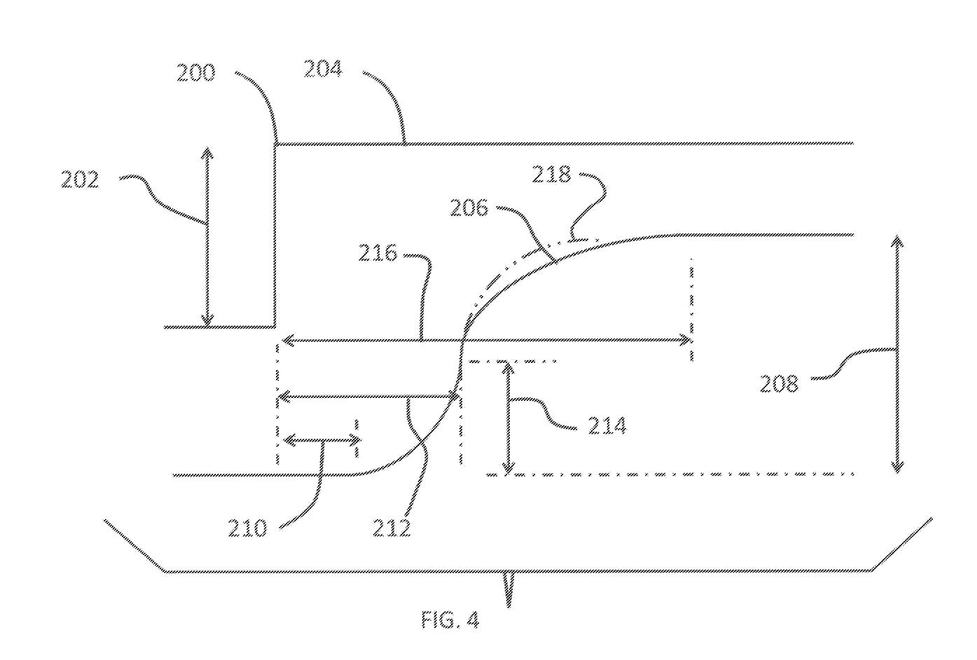

To provide the desired control of the controlled parameters (i.e. pressure and vacuum level), the invention uses a servo control system that automatically determines the natural system response of the system for the different fluid system states and then it determines appropriate control parameters to use with the individual fluid system states based on the determined natural system response for the individual fluid system states. In one embodiment, the determination of the natural system response by the servo control system involves the servo control system 30 imposing a step 200 of a defined step size amount 202 in the value of the drive parameter 204, such as pump voltage, while the fluid system is in a defined fluid system state, as shown in FIG. 4. As a result of the step 200 in the drive parameter 204, the value of the controlled parameter 206, such as vacuum level, begins to change. The amplitude of change 208 and the rate of change of the controlled parameter depend on the natural system response in the defined fluid system state. Various measurements, such as the time delay before the onset of a change 210, the time 212 from the step to the inflection point of the response curve, the value of the change 214 of the response function from the initial value to the value at the inflection point, the time 216 from the step in the drive parameter until the controlled parameter is within a certain range around the final value of the controlled parameter, and the fit parameters of an analytical fit curve 218 used to approximate the measured response of the controlled parameter 206, for example, the fit parameters for a single-pole response function, can be used by the servo control system 30 to characterize the natural system response for the given fluid system state. From the determined natural system response, the controller can determine a new set of control parameter values to be used to optimize the servo control for the natural system response. This process of introducing a step in the drive parameter and monitoring the response of the controlled parameter can be performed as a diagnostic test during a defined test sequence of the printing system. In this example embodiment, the fluid system uses a previously determined or estimated set of control parameters. During the normal course of trying to maintain the controlled parameter at some state dependent level, the controller will need to initiate one or more steps in the drive parameter to shift the controlled parameter closer to the desired value. The response of the controlled parameter to these one or more step changes in drive parameter is then measured using the appropriate sensor and by means of this measured response a new set of control parameters are determined. In other example embodiments, the determination of the control parameters is carried out during the normal operation of the fluid system.

The change in the controlled parameter value is measured using the appropriate sensor, such as vacuum sensor 120. The servo control can analyze the measured response of the controlled parameter to the imposed step of the drive parameter to determine the natural system response in the defined fluid system state. Based on the natural system response, determined in this manner, the servo control system can identify control parameter values to be used when the fluid system is in this defined fluid system state. The identified fluid system parameters for the defined fluid system state are stored in memory for future use by the servo controller when the fluid system is in this defined fluid system state.

In a similar manner, the servo controller can determine the control parameters to use for each of the fluid system states in the set of fluid system states. The identified control parameters for each of the fluid system states can be stored in memory as elements in a table linking the identified control parameters with the corresponding fluid system states. It is common for the sequences of fluid system states to have multiple states which have the same set of configuration parameters, for example a start up sequence might have a series of states alternately open and close the same valve, with no other changes in configuration. As one would expect the multiple states which have the same set of configuration parameters to all have the same response characteristics, some embodiments link the sets of control parameters so that control parameters do not need to be determined for each instance of a state that shares a set of configuration parameters with other states.

The set of control parameters determined for the given fluid system state may then replace the previous sets of control parameter values in the state tables, so that the newly determined set of values of the control parameters are subsequently used in place of the previous sets of values of the control parameters.

In one example embodiment, the newly determined set of control parameter values are compared with the previous set of control parameter values to determine whether the difference is statistically significant. In some embodiments, the analysis to determine whether the currently determined set of control parameter values are statistically different from the previous sets of control parameter values can involve comparisons of the current set of values to a sequence of previous sets of values of the control parameters, using the tools of statistical process control such as the analysis of Shewhart charts, to determine whether the newly determined control parameter values are indicative of some drift or of an outlier in the control parameters. Depending on the results of such an analysis, the value of the control parameters stored in the state table may be left unchanged from the previous control parameter values, it may be replaced by the newly determined values, or the stored value may be replaced by values derived from a combination of previous values and the newly determined value such as through a moving average calculation or through a regression type analysis. In some embodiments, the individual control parameter values that make up the set of control parameter values are individually compared to the corresponding individual control parameter value in one or more previous sets of control parameter values. In other embodiments, a more complex comparison is made between the newly determined set of control parameters and one or more previously determined sets of control parameters that analyzes the set of control parameters as a combined entity to one or more previously determined sets of control parameters. In some embodiments, the operator may be able to prompt the controller to replace the stores sets of control parameters with the newly determined control parameters, following a maintenance operation in which some portion of the fluid system has been replaced or altered such as a pump filter or fluid line.

The results of comparing the set of newly determined control parameter values to one or more sets of previously determined control parameters are used as a diagnostic tool of the fluid system. Through the use of statistical process control tools, determinations can be made to identify system drifts or some other indication that set of control parameters is outside the normal bounds for such control parameters. By analysis of changes in sets of control parameter values for different ones of the fluid system states, the controller may be able to determine not only that something has changed but it may be able to pinpoint the cause for the changes. For example, based on the results of such diagnostics, the controller may be able to determine when operator intervention is needed. The intervention can include but is not limited to replacement of one of the fluid system filters, valves or pumps when the diagnostics indicate an impending failure. The controller may then alert the operator concerning the corrective action to take.

In another example embodiment, the measurements of the response characteristics, which are used to determine the set of control parameter values for a given state, are compared to previous values of those response characteristic measurements as a diagnostic tool of the fluid system rather than comparisons of the determined control parameters. By analysis of changes in response characteristic measurements for different ones of the fluid system states, the controller may be able to determine not only that something has changed but it may be able to pinpoint the cause for the changes. Using such diagnostics, the controller, for example, can determine when various filters should be replaced, or whether a particular valve or pump is showing signs of impending failure. The controller may then alert the operator concerning the corrective action to take.

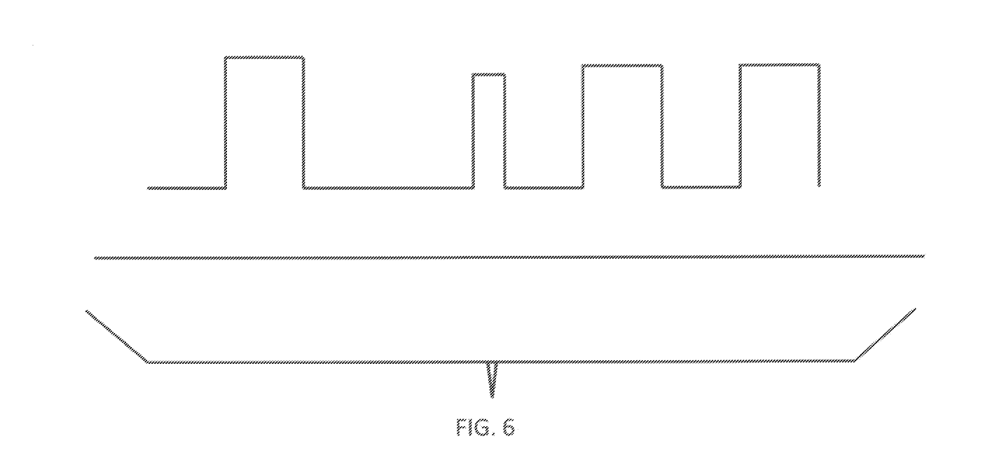

Referring to FIG. 6, in some example embodiments, a more complex drive parameter function can be employed, and the response of the controlled parameter to this drive parameter function can be analyzed. For example, the complex drive parameter function may comprise a sequence of pulses of defined amplitudes, pulse widths, and timing between pulses. Such complex drive functions may be useful if the fluid system response has more than one pole or characteristic response time, such as having separate response characteristics of individual portions of the entire system, such as, but not limited to the pump response time, propagation times of pressure modulations along the fluid lines, and the damping of pressure fluctuations within the fluid lines of the fluid system.

The control parameters are normally determined or confirmed using the simple step in the driven parameter value described above. However, if the diagnostic analysis of the response characteristic measurements or of the determined control parameters indicates a significant change has occurred in these values, a follow up set of diagnostic tests may be initiated. One such follow up diagnostic test can include the use of a complex drive parameter function and the analysis of the response of the controlled parameter to this complex drive parameter function in one or more of the fluid systems states. The use of the more complex drive parameter drive function, for example, the one shown in FIG. 6, can enable better identification of the components in the fluid system that may need to be serviced.

The invention has been described in detail with particular reference to certain preferred embodiments thereof, but it will be understood that variations and modifications can be effected within the scope of the invention.

### PARTS LIST

10 Printing System
20 System Controller
30 Servo Controller
100 Fluid System
102 Printhead Interface Controller
104 Ink Tank
108 Air Supply Valve
110 Ink Pump
112 Printhead
114 Pressure Sensor
116 Outlet Valve
118 Filter
120 Vacuum Sensor
124 Concentration Control
126 Circulation Pump
128 Ink Refill Valve
129 Replenishment Valve
130 Air Pump
132 Vacuum Pump
134 Catcher Valve
136 Catch Pan Valve
138 Ink Supply
140 Replenishment Supply
144 Air Bleed
200 Step
202 Step size
204 Drive Parameter
206 Controlled Parameter
208 Amplitude
210 Time Delay
212 Time to Inflection Point
214 Inflection Point Change
216 Time
218 Fit Curve

1. A method of controlling a selected operating parameter in a device that operates in multiple operating states which include differing natural response characteristics, at least one of the natural response characteristics in at least one of the multiple operating states being variable over time, the selected operating parameter of the device being controlled by changes in a drive parameter of the device with a servo controller that includes control parameters which are responsive to at least one of the natural response characteristics, the method comprising:
providing sets of control parameters to the servo controller, the sets corresponding to the multiple operating states of the device;
selecting one of the sets of control parameters corresponding to a given operating state of the device to be used by the servo controller to initiate control of the selected operating parameter in the given operating state;
measuring a response of the selected operating parameter in the given operating state of the device while the drive parameter of the device is being controlled by the servo controller using the selected set of control parameters;
modifying the selected set of control parameters used by the servo controller based on the response; and
continuing to control the selected operating parameter of the device in the given operating state with the servo controller using the modified set of control parameters.

2. The method of claim 1, further comprising:
storing the modified set of control parameters for subsequent as an initial set of control parameters for the given operating state.

3. The method of claim 2, further comprising:
establishing a history for the given operating state by storing a plurality of modified sets of control parameters for the given operating state.

4. The method of claim 3, further comprising:
analyzing the history of the given operating state to determine the possibility of conditions that necessitate intervention by an operator.

5. The method of claim 2, further comprising:
establishing a history for multiple given operating states by storing a plurality of modified sets of control parameters for multiple given operating states.

6. The method of claim 5, further comprising:
analyzing the history of the multiple given operating states to determine the possibility of conditions that necessitate intervention by an operator.

7. The method of claim 1, wherein measuring the response of the selected operating parameter in the given operating state of the device while the selected operating parameter is being controlled by the servo controller using the selected set of control parameters includes initiating a defined step in the drive parameter while in the given operating state of the device and then measuring the selected operating parameter in the given operating state of the device.

8. The method of claim 7, wherein initiation of the defined step in the drive parameter while in the given operating state of the device occurs when the device is off-line.

9. The method of claim 1, wherein measuring the response of the selected operating parameter in the given operating state of the device while the selected operating parameter is being controlled by the servo controller using the selected set of control parameters includes initiating a sequence of defined steps in the drive parameter while in the given operating state of the device and then measuring the selected operating parameter in the given operating state of the device.

10. The method of claim 9, wherein initiation of the defined steps in the drive parameter while in the given operating state of the device occurs when the device is off-line.
